(19) United States
(12) Patent Application Publication
(10) Pub. No.: US 2009/0155614 A1
(43) Pub. Date: Jun. 18, 2009

(54) Polypropylene Materials and Method of Preparing Polypropylene Materials

(75) Inventors: Michael A. McLeod, Kemah, TX (US); John Ashbaugh, Houston, TX (US); Michael Musgrave, Houston, TX (US)

Correspondence Address: FINA TECHNOLOGY INC, PO BOX 674412, HOUSTON, TX, 77267-4412, US

(73) Assignee: FINA TECHNOLOGY, INC., Houston, TX (US)

(21) Appl. No.: 11/956,806

(22) Filed: Dec. 14, 2007

(51) Int. Cl. B32B 27/06; C08F 210/00

(52) U.S. Cl. 428/516; 526/348

(57) ABSTRACT

A polypropylene material may be prepared from a blend of heterophasic propylene copolymers and propylene homopolymers. The material may be prepared by blending the polymers while they are in a molten state, and forming a film or sheet from the polymer blend. The materials may also be formed as coextruded materials or as ternary blends with a polyethylene or a single phase random propylene copolymer. The blends and neat polymers have particular application to forming slit film tapes and similar materials. The resultant materials may exhibit increased tenacity, elongation and toughness and greater surface roughness as compared to those materials prepared solely from propylene homopolymers.

### BACKGROUND OF THE INVENTION

1. Technical Field

The invention relates generally to materials prepared from polypropylene, and more particularly, to films and similar materials prepared from polypropylene blends, such as blends of propylene homopolymers and propylene impact copolymer.

2. Background of the Art

Polypropylene may be used in the manufacture of a variety of materials. In particular, polypropylene has been found useful in forming films and similar materials having a small or reduced thickness. One such material includes slit film tapes, which are used for a variety of applications. Common applications for polypropylene slit film tapes include carpet backing; industrial-type bags, sacks, or wraps; ropes or cordage; artificial grass and geotextiles. They may be particularly useful in woven materials or fabrics that require a high degree of durability and toughness. It may be beneficial if the slit film tape can process easily and be resistant to breakage during all phases of the life of the tape, including manufacturing, weaving, and in the final fabric.

Manufacturing of polypropylene slit film tapes is an extrusion process well known in the art, and inferior processability and strength may result in reduced extrusion efficiencies. Slit film tapes that break during weaving result in reduced loom efficiencies as well as a higher level of fabric defects.

Generally speaking, polymers are materials prepared by the polymerization of a single monomer. Copolymers are materials prepared by the copolymerization of at least two monomers. For the purposes of this disclosure and to avoid prolixity, the term polymer, unless otherwise indicated by context may also refer to copolymers.

### SUMMARY OF THE INVENTION

In one aspect, the invention is a polypropylene fiber, film, or sheet prepared using a melt blended admixture of a heterophasic propylene copolymer and an isotactic propylene homopolymer wherein the heterophasic propylene copolymer has an ethylene content of from about 5% to about 25% by weight of copolymer and is present in an amount of greater than 40% to about 75% by weight of polymer blend and has a melt flow rate (MFR) of from about 4 to about 25.

In another aspect, the invention is a polypropylene fiber, film, or sheet prepared using a melt blended admixture of a heterophasic propylene copolymer; an isotactic propylene homopolymer; and a polymer selected from the group consisting of polyethylene and single phase random propylene copolymers. The heterophasic propylene copolymer has an ethylene content of from about 5% to about 25% by weight of copolymer and is present in an amount of from about 5% to about 90% by weight of polymer blend.

Another aspect of the invention is a composition including a melt blended admixture of a heterophasic propylene copolymer; an isotactic propylene homopolymer; and a polymer selected from the group consisting of polyethylene and single phase random propylene copolymers. The heterophasic propylene copolymer has an ethylene content of from about 5% to about 25% by weight of copolymer and is present in an amount of from about 5% to about 90% by weight of polymer blend.

In still another aspect, the invention is a polypropylene material which includes a three layer coextruded film or sheet prepared by the coextrusion of a first layer, a second or middle layer, and a third layer. Each layer is prepared using a material selected from the group consisting of a heterophasic propylene copolymer; an isotactic propylene homopolymer; a melt blended admixture of a heterophasic propylene copolymer and an isotactic propylene homopolymer wherein the heterophasic propylene copolymer has an ethylene content of from about 5% to about 25% by weight of copolymer and is present in an amount of greater than 40% to about 75% by weight of polymer blend; and a melt blended admixture of a heterophasic propylene copolymer; an isotactic propylene homopolymer; and a polymer selected from the group consisting of polyethylene and single phase random propylene copolymers; wherein the heterophasic propylene copolymer has an ethylene content of from about 5% to about 25% by weight of copolymer and is present in an amount of from about 5% to about 90% by weight of polymer blend.

### BRIEF DESCRIPTION OF THE FIGURES

For a detailed understanding and better appreciation of the invention, reference should be made to the following detailed description of the invention taken in conjunction with the accompanying drawings, wherein:

FIG. 1: is a schematic diagram of a slit film tape line;

FIG. 2 is a diagram of a tenter-frame process including equipment for co-extrusion and/or extrusion coating of exterior layers around a core layer;

FIG. 3 is a graph showing yield stress versus preheating time at 135° C. stretching temperature for Example 2;

FIG. 4 is a graph showing yield stress versus preheating time for Example 2;

FIG. 5 is a graph showing shrinkage for films stretched at various preheating times for Example 2;

FIG. 6 is a graph showing yield stress versus stretching temperature for Example 3; and

FIG. 7 is a graph showing yield stress versus drawing temperature for Example 3;

### DETAILED DESCRIPTION OF THE INVENTION

Propylene impact copolymers, which are sometimes referred to in the art ICP or ICP polymers, and are also referred to herein as heterophasic propylene copolymers, are typically used in the productions of thermoformed articles and various molded articles, such as those formed through injection molding, requiring high impact strength. These polymers, although particularly well suited for such molded articles, have not been widely used in the manufacture of films. It has been found, however, that by combining such impact copolymers as a blend with a propylene homopolymer, improvements in such materials may be achieved, particularly with respect to slit film tapes.

The heterophasic propylene copolymers used in the present invention are heterophasic copolymers of propylene and ethylene. These polymers are typically made up of three components. These include a semi-crystalline propylene homopolymer, a rubbery propylene rich ethylene-propylene copolymer and a semi-crystalline polyethylene polymer. The typical heterophasic morphology of the heterophasic propylene copolymer consists of generally spherical domains of rubbery ethylene-propylene copolymer dispersed within the semi-crystalline propylene homopolymer matrix. The amount and properties of the components are controlled by the process conditions and the physical properties of the resulting material are correlated to the nature and amount of the three components. The heterophasic propylene copolymers may have a room temperature notched IZOD impact strength of from about 2 to at least about 6 ft-lb/in, as measured by ASTM D-256. Unless otherwise specified, all notched IZOD impact strength may be measured according to ASTM D-256.

The polymerization reaction used to produce such impact copolymers is often carried out in a two-reactor configuration in which a catalyst and propylene are introduced into a first reactor in which the propylene homopolymer may be produced. The propylene homopolymer may be then transferred to one or more secondary reactors where ethylene monomer may be added to produce the ethylene-propylene rubber component of the polymer.

The propylene heterophasic copolymers may be those prepared by copolymerizing propylene with ethylene in the amounts of from about 80 to about 95% by weight of propylene and from about 5 to about 25% by weight ethylene. Examples of catalysts used to produce these copolymers may include Ziegler-Natta and metallocene catalysts commonly employed in the polymerization of polypropylene. The propylene copolymer may be prepared using a controlled morphology catalyst that produces ethylene-propylene copolymer spherical domains dispersed in a semi-crystalline polypropylene matrix. In the present invention, the amount of ethylene in the heterophasic propylene copolymer may be from about 7 to about 15% by weight. Typical melt flow rates (MFR) for the heterophasic copolymer resins used are from about 2 g/10 min to about 8 g/10 min but the MFR may be as high a 25 g/10 minutes. Unless otherwise stated all melt flow rates presented are measured according to ASTM D-1238, Condition L. An example of a suitable commercially available heterophasic copolymer is that marketed as TOTAL 4320, available from TOTAL Petrochemicals, Inc., Houston, Tex. In some embodiments, the MFR may be from about 10 to about 20 g/10 minutes.

Although not necessarily required, the resultant propylene heterophasic copolymer fluff or powder may be modified to improve the copolymer's impact strength characteristics and other properties. This may be done through the use of elastomeric modifiers, or with peroxides, using controlled rheology techniques. When using elastomeric modifiers, the elastomeric modifiers are melt blended with the propylene copolymer, which facilitates improvements in the energy-absorption behavior of the heterophasic propylene copolymer, contributing to a higher impact strength. Examples of elastomeric modifiers include ethylene propylene rubber (EPR) and ethylene propylene diene monomer (EPDM).

Controlled rheology techniques, commonly known in the art, are used to modify the EPR morphology to enhance impact strength. This technique uses peroxides or other suitable oxidizing agents.

Additionally, other additives, such as stabilizers, antioxidants, nucleating additives, acid neutralizers, anti-static agents, lubricants, filler materials, etc., which are well known to those skilled in the art, may also be combined with the propylene copolymer within the extruder.

The heterophasic propylene copolymer used in the present invention will typically have an ethylene-propylene rubber or EPR phase of from about 5% or more by weight of copolymer. An EPR content range may be from about 5% to about 50% by weight of copolymer, with from about 7% to about 20% by weight of copolymer being typical, and from about 10% to about 15% by weight of copolymer being more typical.

The propylene homopolymer used for the present invention may be an isotactic polypropylene. The polypropylene may be prepared from conventional stereospecific catalysts used for preparing semi-crystalline isotactic polymers, such as Ziegler-Natta or metallocene catalysts. The polypropylene may also contain small amounts of non-isotactic polypropylene, for example syndiotactic or atactic polypropylene, which may be present in amounts of typically less than about 2% or 1% by weight of polypropylene. The homopolymer will typically have a melt flow rate of from about 2 g/10 min to about 8 g/10 min, but may be as high as 25 g/10 min. The propylene homopolymer may include small amounts of comonomer, such as the C₂ to C₈ olefins. Such comonomer content may make up less than 1% by weight of the polymer, less than 0.5% by weight of the polymer, or less than 0.1% by weight of polymer. An example of a suitable commercially available propylene homopolymer may be that marketed as TOTAL 3365, available from TOTAL Petrochemicals, Inc., Houston, Tex.

In preparing the materials of the invention, both the propylene homopolymer and propylene impact copolymer may be blended together in a molten state. The amount of impact copolymer used with the homopolymer may, in some embodiments, be from about 5% to about 90% by total weight of polymer. In other embodiments, the copolymer may be used in an amount of less than 80% by total weight of polymer, or may be less than 70% by total weight of polymer, with the propylene homopolymer making up greater than 20% or 30% by total weight of polymer, respectively. The propylene impact copolymer content may include ranges of from about 20% to about 80% by total weight of polymer, or from about 30% to about 70% by total weight of polymer. The impact copolymer can also be used in an amount of from about 40% to about 60% by total weight of polymer.

The propylene homopolymer and copolymer may be mixed together in pelletized, fluff or powder form prior to being introduced into an extruder. In certain instances, the polymers may be dry blended together prior to being introduced into the extruder. Alternatively, the polymers may be introduced separately into the extruder at a position to achieve thorough mixing of the polymers within the extruder, such as with a gravimetric or volumetric blender, which are commonly known in the art. The melt flow rate of the resulting polymer may be from about 2 g/10 min to about 8 g/10 min, but may be as high as 15 g/10 min, with from 3 g/10 min to about 5 g/10 min being typical.

Additives or processing aids may be combined with the polymers as well during this extrusion process. Typical additives for films and sheet-like materials, such as slit film tapes, which are well known to those skilled in the art, include UV stabilizers, antioxidants, antistatic agents, stearates, calcium carbonate, coloring additives, fluoropolymers and polyethylene.

Although the polypropylene material may be used in forming different film or sheet-like materials having a generally small or reduced thickness, the polymers have particular application to slit film tapes. Accordingly, the following description is with reference to such tapes. It should be apparent to those skilled in the art, however, that the invention is not limited to such tapes, but would apply to the same or similar materials where similar properties are desired. For example, the invention may be useful in preparing monofilament tapes.

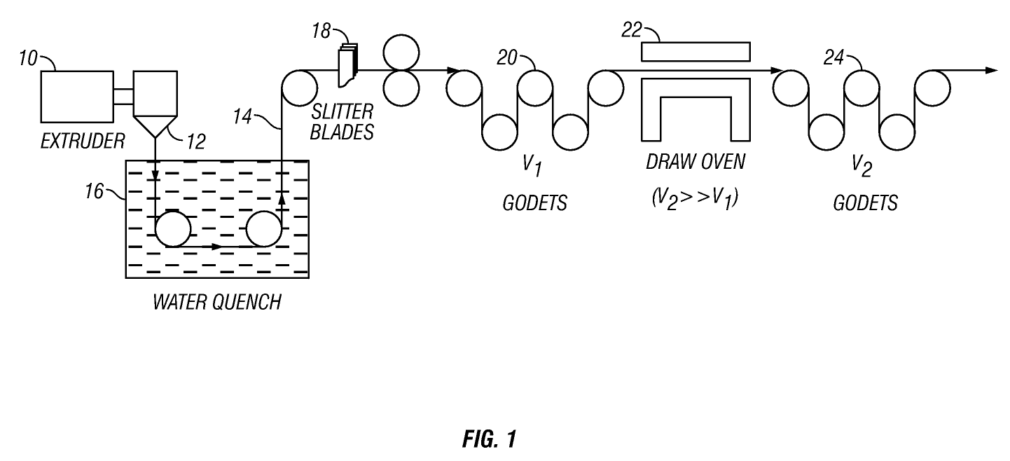

Referring to FIG. 1, which schematically illustrates one example of a slit film line, the polymers, as well as any additives, are melt blended within an extruder 10 and passed through a die 12 to form a layer of film 14. Alternatively, the blended polymer may be formed into pellets for use at a later time. For slit film tape applications the film die will typically have a die opening of from about 10 to 30 mils to form a film of similar thickness. Upon extrusion through the die, the film is typically quenched in a water bath 16 (typically about 70 to 100° F.) or otherwise cooled, such as by the use of cooling rollers (not shown).

After quenching, the film is slit longitudinally into one or more tape segments or slit film tapes. This is usually accomplished through the use of a slitter 18 consisting of a plurality of blades spaced laterally apart at generally equal distances. The tapes are typically slit into widths of from about 0.25 to about 2 inches, more usually from about 0.5 to about 1 inches, but may vary depending upon the application for which the tapes will be used.

The slit film tapes are then drawn or stretched in the machine or longitudinal direction. This is usually accomplished through the use of rollers or godets 20, 24 set at different rotational speeds to provide a desired draw ratio. A draw oven 22 for heating of the slit film tape to facilitate this drawing step may be provided. For slit film tapes, draw ratios are usually from about 3:1 to about 12:1, with from about 5:1 to about 7:1 being more typical. Drawing of the slit film tapes orients the polymer molecules and increases the tensile strength of the tapes. The final thickness of the drawn tapes is typically from 0.5 mils to 5 mils, with from 1 to 3 mils being more typical. The width of the drawn tapes is typically from about 0.025 inches to about 0.70 inches, with from about 0.05 inches to about 0.4 inches being more typical.

After the tapes are drawn, they may be annealed in an annealing oven or on annealing godets (not shown). Annealing reduces internal stresses caused by drawing or stretching of the tape. This annealing reduces tape shrinkage. The tapes are then wound onto bobbins.

Tapes may be individually extruded as well in a direct extrusion process. In such a process, instead of slitting a plurality of tapes from a film, a plurality of individual tapes are extruded through multiple die openings.

In some embodiments of the invention, the polypropylene tapes produced in accordance with the present invention may exhibit better drawability and other physical properties than those prepared from conventional propylene homopolymers. Those tapes prepared with blends of propylene homopolymers and impact copolymers may exhibit a greater tenacity and better elongation than conventional polypropylene tapes. Specifically, the tapes of the invention may generally exhibit a tenacity at maximum load that is at least 5 g/den at a draw ratio of 7.5:1 and an elongation at maximum of at least 15% at the same draw ratio. The tapes may further exhibit a toughness of greater than 5 in-lbf at most draw ratios and blends, with a toughness of greater than 8 in-lbf being readily obtainable in most instances.

Compared to tapes prepared solely from the isotactic propylene homopolymer, tapes prepared from the polymer blends of some embodiments of the invention may exhibit tenacities at a draw ratio of 7.5:1 that is at least 10% greater than a homopolymer tape prepared under similar conditions. Further, these tapes may exhibit elongation at maximum at a draw ratio of 7.5:1 that may be at least 10% greater than the homopolymer tapes prepared under similar conditions.

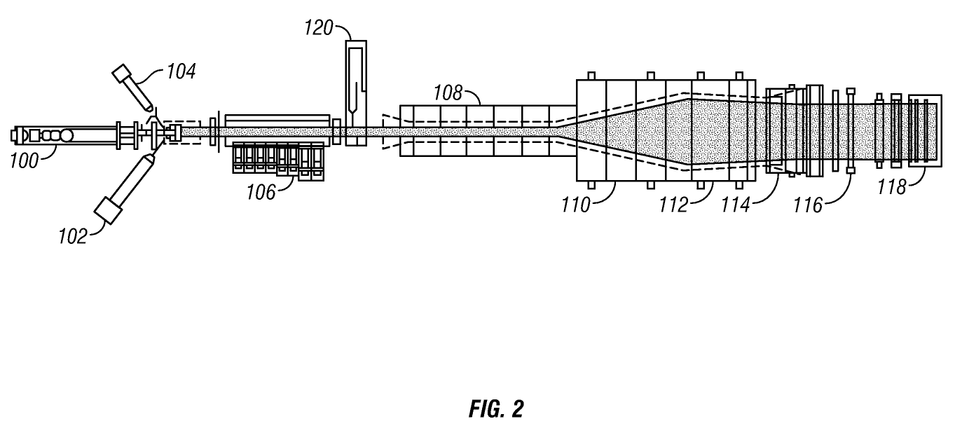

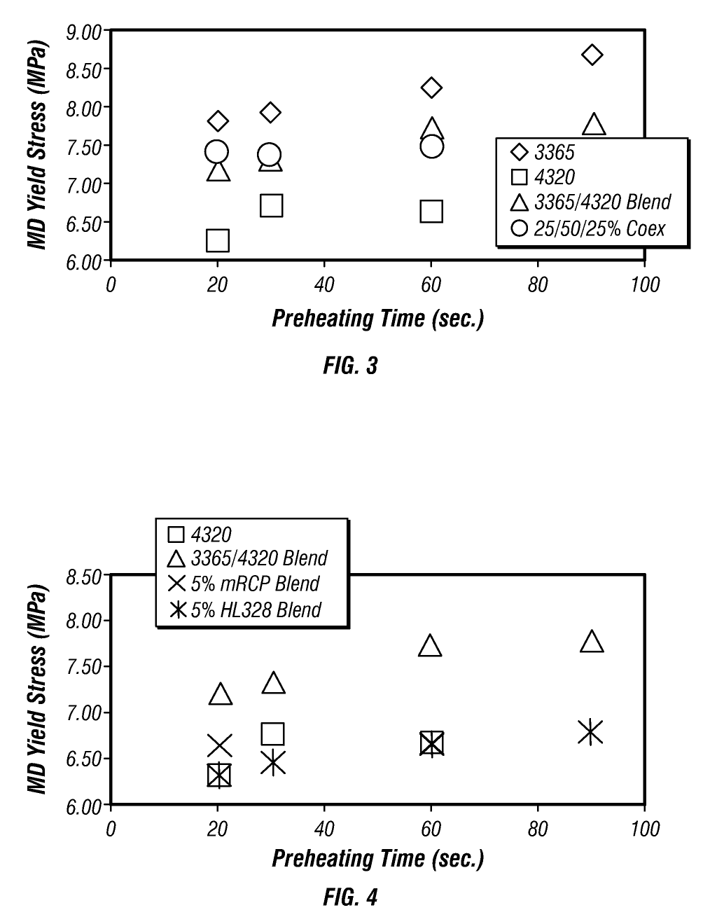

The tapes of some embodiments of the invention also exhibit a unique matte appearance in contrast to isotactic propylene homopolymers, which appear shiny or glossy, thus the need for mechanical delustering may be eliminated. When compared to the same isotactic homopolymers used in the blends without heterophasic propylene, prepared under the same or similar conditions without delustering, as much as 50, 60, 70, 80, 90, 100% or greater increases in surface roughness can be achieved, as determined by Rms and/or Ra values, using atomic force microscopy (AFM) measurements, As used herein, Rms is the root mean square average of height deviation and Ra is average roughness as determined by tapping mode Nanoscope AFM measurements. FIGS. 2 and 3 show the difference in the three-dimensional surfaces of two tape samples prepared from an heterophasic propylene copolymer:iPP blend and an iPP homopolymer, respectively. The films or sheets of the invention may exhibit a surface Rms that is at least about 50% greater than that of the isotactic propylene homopolymer prepared under the same conditions.

In addition to tapes and sheets, in some embodiments, the invention is used to prepared a monofilament fiber. The fibers of the invention may be prepared using any method known to be useful to those of ordinary skill in the art of preparing monofilament fibers. The fibers prepared using the invention may have a denier (g/9000 meters) of from about 50 to 5000.

In another embodiment, the invention is a polypropylene material including a film or sheet of a melt blended admixture where the melt blended admixture includes a heterophasic propylene copolymer; an isotactic propylene homopolymer; and a third polymer selected from the group including medium density polyethylene and metallocene random copolymers. In this embodiment, the heterophasic propylene copolymer has an ethylene content of from about 5% to about 25% by weight of copolymer and is present in an amount of from about 5% to about 90% by weight of polymer blend. This ternary blend, in some embodiments, may reduce stretching forces relative to either of the heterophasic propylene copolymer or the isotactic propylene homopolymer alone or in admixture. Further, the ternary blends may also decrease temperature effects so that they approach that of the neat isotactic polypropylene. Finally, the ternary blends produce a sheet or film that has a duller finish than the neat isotactic polypropylene.

One aspect of the ternary blend materials that may be useful in certain application is that they show an increase in shrinkage. This may be useful in high shrink oriented film applications.

The heterophasic propylene copolymer and isotactic propylene homopolymer components of the ternary blend are the same as those already described herein. The third component is selected from the group consisting of polyethylene and single phase random propylene copolymers. The third component is, in some embodiments, present at a concentration of from about 1 to about 15 weight percent of the polymer blend. In another embodiment, the third component is present at a concentration of from about 5 to 10 weight percent of the polymer blend.

When the third component is polyethylene, it may be selected from those polyethylene polymers having a density of from about 0.85 to about 0.97. For example, in one embodiment, the polyethylene may be a medium density polyethylene such as a polyethylene prepared using a chromium catalyst and having a density of about 0.937 and melt index of 0.28, such as TOTAL HL-328.

When the third component is a single phase random propylene copolymer, it may be one selected from those having a melting point of from about 110 to about 155° C.; and MFR of from about 0.5 to about 50 g/10 minutes. For example, it may be a metallocene catalyzed random copolymer, obtained from Total Petrochemicals, which is a propylene-ethylene metallocene random copolymer having a melting point of 120° C. and a MFR of about 12 g/10 minute at 190° C., hereinafter referred to as mRCP.

In still another aspect, the invention is a polypropylene material including a three layer coextruded film or sheet. Each of the three layers may be the same or different and are prepared from materials selected from the group consisting of a heterophasic propylene copolymer; an isotactic propylene homopolymer; a melt blended admixture of a heterophasic propylene copolymer and an isotactic propylene homopolymer wherein the heterophasic propylene copolymer has an ethylene content of from about 5% to about 25% by weight of copolymer and is present in an amount of greater than 40% to about 75% by weight of polymer blend; and a melt blended admixture of a heterophasic propylene copolymer; an isotactic propylene homopolymer; and a polymer selected from the group consisting of polyethylene and single phase random propylene copolymers; wherein the heterophasic propylene copolymer has an ethylene content of from about 5% to about 25% by weight of copolymer and is present in an amount of from about 5% to about 90% by weight of polymer blend. The weight of each layer may represent from 20 to 80 percent of the total weight of the three layer coextruded film or sheet.

In one embodiment, the three layer coextruded film or sheet is prepared by the coextrusion of a first layer of a heterophasic propylene copolymer onto a first side of an isotactic propylene homopolymer layer and a second layer of a heterophasic propylene copolymer extruded onto a second side of the isotactic propylene homopolymer layer. In this embodiment, the heterophasic propylene copolymer and isotactic propylene homopolymer may be selected from those already described herein. The isotactic propylene homopolymer center layer may be from about 40 to about 80 percent, by weight, of the total weight of the three layer coextruded film. In some embodiments, the isotactic propylene homopolymer center layer may be from about 50 to about 70 percent, or 55 to 65 percent by weight, of the total weight of the three layer coextruded film. The first and second heterophasic propylene copolymer layers may be of the same or different wrights and thicknesses.

In one embodiment where it is desired to lower the processing energy as much as possible at least two and maybe all three of the layers of the three layer coextruded film or sheet are prepared using a melt blended admixture of a heterophasic propylene copolymer and an isotactic propylene homopolymer wherein the heterophasic propylene copolymer has an ethylene content of from about 5% to about 25% by weight of copolymer and is present in an amount of greater than 40% to about 75% by weight of polymer blend; and/or a melt blended admixture of a heterophasic propylene copolymer; an isotactic propylene homopolymer; and a polymer selected from the group consisting of polyethylene and single phase random propylene copolymers; wherein the heterophasic propylene copolymer has an ethylene content of from about 5% to about 25% by weight of copolymer and is present in an amount of from about 5% to about 90% by weight of polymer blend

The three layer coextruded film or sheet may be prepared by any means known to those of ordinary skill in the art of preparing such films and sheets. For example, in one embodiment of the invention a main extruder is used to prepare the center isotactic propylene homopolymer while two supplemental extruders are used to prepare the two layers of heterophasic propylene copolymer which are, in effected, applied to both sides of the center layer. One apparatus for preparing such a material is illustrated in FIG. 2.

Referring now to FIG. 2, FIG. 2 is a schematic diagram illustrating a tenter-frame process including the capability of co-extruding one or two surface layers with the core layer. The main extruder 100 is flanked by two supplemental extruders 102 and 104. Through the operation of one of the supplemental extruders 102 or 104 a separate polymer or polymer blend may be extruded to be in contact with the primary polymer or polymer blend emerging from main extruder 100. If both supplemental extruders 102 and 104 are used, then a sandwich may be created with the primary polymer forming the core layer, and the polymers extruded by the supplemental extruders 102 and 104 forming surface layers.

In general, the surface layers may be identical or may be of different polymers or polymer blends, as the illustrated supplemental extruders 102 and 104 may pull from hoppers or sources of polymer separate from each other as well as being separate from the source for extruder 100. In the case of the present invention, both surface layers are heterophasic polypropylene. After extrusion and casting, the multi-layer film continues through the machine direction orientation section 106, pre-heating section 108, transverse direction orientation section 110, annealing section 112, cooling section 114, corona treating section 116, and finally the take-up (or wind-up) section 118. In an alternative method also available in FIG. 2, exterior layers may be added in the extrusion coating section 120, after machine direction orientation, but before transverse direction orientation. In extrusion coating section 120, additional material is extruded to coat either one or both surfaces of the mono-axially oriented film emerging from machine direction orientation section 106. The mono-axially oriented film to be extrusion coated may be a mono-layer film generated by primary extruder 100, or may be a multi-layer film created by co-extrusion by a combination of main extruder 100 and supplemental extruders 102 and 104.

The 3 layer coextruded polypropylene compositions of the invention may, in some embodiments of the invention, ease stretching forces relative to neat isotactic propylene homopolymer. In other embodiments, the 3 layer coextruded polypropylene compositions may have a low gloss finish and/or lower shrinkage relative to the neat isotactic propylene homopolymer.

The invention having been generally described, the following examples are given as particular embodiments of the invention and to demonstrate the practice and advantages thereof. It is understood that the examples are given by way of illustration and are not intended to limit the specification or the claims to follow in any manner.

### Test Methods

Density. Density may be determined using ASTM D792 or ASTM D1505.

Elongation at Break. Elongation at break may be determined using ASTM D790.

Elongation at Yield. Elongation at yield may be determined using ASTM D790.

Flexural Modulus. Flexural modulus may be measured suing ASTM D638.

Gloss. 450 gloss may be determined using ASTM D2547.

Haze. Haze may be determined using ASTM D1003.

Melt Flow Rate (MFR). This property may be determined using ASTM D1238, including both procedure A (manual operation) and procedure B (automatically timed flow).

Melting Point. Determined using a differential scanning calorimeter (DSC).

Shrinkage. Shrinkage may be determined using ASTM D1204.

Tensile Modulus. Tensile modulus may be measured suing ASTM D638.

Tensile Strength. Tensile strength may be measured suing ASTM D638.

Water Vapor Transmission Rates. WVTR may be determined using E-96

### EXAMPLES

### Example 1

### Tape Testing

Polypropylene resins prepared from Ziegler-Natta catalysts were used in the evaluations. Specifically, TOTAL 3365 was used as the propylene homopolymer and four heterophasic propylene copolymers as shown below in Table 1-1 were used as the impact copolymer. Tapes were prepared using a Bouligny Tape Line at the conditions shown in Table 1-2. The polymers further had the following properties, also as set forth in Table 1-1. The resulting tapes had the properties shown in Tables 1-3 (A-E). The control was the homopolymer alone while the blends were 1:1 weight blends. Tenacity, elongation, tensile moduli and toughness of the slit film tapes were measured using an INSTRON Model 1122 retrofitted to a model 5500 in a constant rate tensile loading mode using 50 lb (load cell and pneumatic clamping cord and yarn grips). The gauge length was set at 5 inches/minute. Tape tension was measured using a hand held tensiometer. Energy as shown in the tables was the comparative amperage required for processing.

### Discussion of Example 1 Results

Example 1 illustrates the reduced processing energy required when using a heterophasic propylene copolymer having a melt flow rate of greater than 4 g/10 min.

TABLE 1-1
Materials Used

| | | | TOTAL Product |
|---|---|---|---|
| Blend # | Type | MFR | ID |
| 1 | Homopolymer | 3.8 | 3365 |
| 2 | ICP | 18 | 5724 |
| 3 | ICP | 3.7 | 4320 |
| 4 | ICP | 3.8 | 4320WZ |
| 5* | ICP | 0.8 | 4180 |

*Not an example of the invention

TABLE 1-2
Tape Line Conditions

| Settings | Values |
|---|---|
| Denier | 1000 |
| Barrel Profile | 390-480/ |
| | ° F./° C. |
| Die | 480/ |
| | ° F./° C. |
| Die Gap | 15 mm |
| Water Bath | 80/ |
| | ° F./° C. |
| Take Away Speed | 100/ |
| | fpm/mpm |
| RS1A, RS1B | 100/ |
| | fpm/mpm |
| | at ambient |
| Oven | 390/ |
| | ° F./° C. |
| Draw Ratio | 5, 5.6, 7.5, 8, 8.5, 9, 10 |
| Annealing | 320/ |
| | ° F./° C. |
| Relaxation | 15 percent |

TABLE 1-3A
Draw Ratio 6.6:1

| | Blend #1 | | | | |
|---|---|---|---|---|---|
| Property | Control | Blend #2 | Blend #3 | Blend #4 | Blend #5 |
| Energy | 37 amp | 26 amp | 32 amp | 31 amp | na |
| Tension | 1100 g | 425 g | 1000 g | 800 g | na |
| Ten@ 5% | 1.7 | 1.4 | 1.6 | 1.6 | na |
| g/denier | | | | | |
| Mod @ 5% | 29 | 23 | 28 | 26.6 | na |
| g/denier | | | | | |
| Ten @ Max | 6.2 | 5.1 | 6.4 | 6.1 | na |
| g/denier | | | | | |
| Ten @ | 6.2 | 5.1 | 6.4 | 6.1 | na |
| Break | | | | | |
| % Elong | 27 | 34 | 33.4 | 34 | na |
| @Max | | | | | |
| % Elong @ | 31.5 | 34 | 33.4 | 34 | na |
| Break | | | | | |
| % Shrink | 2.5 | 3.2 | 2.7 | 2.2 | na |
| # of Breaks | 0 | 0 | 0 | 0 | 43 |

TABLE 1-3B
Draw Ratio 7.5:1

| | Blend #1 | | | | |
|---|---|---|---|---|---|
| Property | Control | Blend #2 | Blend #3 | Blend #4 | Blend #5 |
| Energy | 37 amp | 28 amp | 34 amp | 34 amp | na |
| Tension | 1500 g | 750 g | 1400 g | 1300 g | na |
| Ten@ 5% | 2 | 1.6 | 1.9 | 1.8 | na |
| g/denier | | | | | |
| Mod @ 5% | 35 | 26 | 32 | 31 | na |
| g/denier | | | | | |
| Ten @ Max | 5 | 5.4 | 6.9 | 6.4 | na |
| g/denier | | | | | |
| Ten @ | 5 | 5.4 | 6.9 | 6.4 | na |
| Break | | | | | |
| g/denier | | | | | |
| % Elong | 16.7 | 27.5 | 28.5 | 27.1 | na |
| @Max | | | | | |
| % Elong @ | 19.5 | 27.5 | 28.5 | 27.4 | na |
| Break | | | | | |
| % Shrink | 3 | 3 | 3.1 | 2.5 | na |
| # of Breaks | 9 | 1 | 6 | 0 | 43 |

TABLE 1-3C
Draw Ratio 8:1

| | Blend #1 | | | | |
|---|---|---|---|---|---|
| Property | Control | Blend #2 | Blend #3 | Blend #4 | Blend #5 |
| Energy | 39 amp | 29 amp | 35 amp | 35 amp | na |
| Tension | >1500 g | 900 g | >1500 g | 1500 g | na |
| Ten@ 5% | 2.2 | 1.9 | 2 | 2 | na |
| g/denier | | | | | |
| Mod @ 5% | 39 | 30.7 | 34.6 | 34.7 | na |
| g/denier | | | | | |
| Ten @ Max | 5.1 | 5.3 | 6.5 | 6.1 | na |
| g/denier | | | | | |
| Ten @ | 5.1 | 5.3 | 6.5 | 6.1 | na |
| Break | | | | | |
| g/denier | | | | | |
| % Elong | 14.4 | 20.6 | 23 | 21.1 | na |
| @Max | | | | | |
| % Elong @ | 17.4 | 23.4 | 24.5 | 24.7 | na |
| Break | | | | | |
| % Shrink | 2.4 | 3.2 | 3 | 2.8 | na |
| # of Breaks | 32 | 1 | 7 | 13 | 43 |

TABLE 1-3D
Draw Ratio 8.5:1

| | Blend #1 | | | | |
|---|---|---|---|---|---|
| Property | Control | Blend #2 | Blend #3 | Blend #4 | Blend #5 |
| Energy | na | 31 amp | 35 amp | 36 amp | na |
| Tension | na | 1300 g | >1500 g | >1500 g | na |
| Ten@ 5% | na | 1.9 | 2.2 | 2 | na |
| g/denier | | | | | |
| Mod @ 5% | na | 32.6 | 38.2 | 35 | na |
| g/denier | | | | | |
| Ten @ Max | na | 5.3 | 6.5 | 6.6 | na |
| g/denier | | | | | |
| Ten @ | na | 5.3 | 6.5 | 6.6 | na |
| Break | | | | | |
| g/denier | | | | | |
| % Elong | na | 20 | 21.4 | 24 | na |
| @Max | | | | | |
| % Elong @ | na | 21.8 | 22.7 | 25 | na |
| Break | | | | | |
| % Shrink | na | 2.8 | 2.9 | 1.9 | na |
| # of Breaks | 43 | 11 | 22 | 32 | 43 |

TABLE 1-3E
Draw Ratio 9:1

| | Blend #1 | | | | |
|---|---|---|---|---|---|
| Property | Control | Blend #2 | Blend #3 | Blend #4 | Blend #5 |
| Energy | na | 36 amp | 35 amp | na | na |
| Tension | na | >1300 g | >1500 g | >1500 g | na |
| Ten@ 5% | na | 1.7 | 2.1 | na | na |
| g/denier | | | | | |
| Mod @ 5% | na | 29.6 | 36.9 | na | na |
| g/denier | | | | | |
| Ten @ Max | na | 5.5 | 6.6 | na | na |
| g/denier | | | | | |
| Ten @ | na | 5.5 | 6.6 | na | na |
| Break | | | | | |
| g/denier | | | | | |
| % Elong | na | 23 | 22 | na | na |
| @Max | | | | | |
| % Elong @ | na | 24.5 | 23.7 | na | na |
| Break | | | | | |
| % Shrink | na | 2.1 | 2 | na | na |
| # of Breaks | 43 | 34 | 32 | 43 | 43 |

### Example 2

### Biaxial Stretch Evaluation

Six sheet structures were prepared using the materials listed in Table 2-1. The blended materials were prepared by melt blending. The coextruded materials were prepared as a sandwich composition with the center layer being the isotactic propylene homopolymer and the heterophasic propylene being on both sides of the center layer. These materials were stretched biaxially to a 6×6 area draw ratio. The resultant materials were tested and the results are displayed in FIGS. 3-5 and in Tables 2-1 through 2-13.

### Discussion of Example 2 Results

Coextruding 4320 skins onto a 3365 core yielded materials that could be processed with eased or lower stretching forces. Stretching forces were reduced relative to neat 3365. Both yield stresses and final draw stresses tended to be halfway between neat 3365 and 4320. The coextruded material had comparatively low gloss (matte finish) while clarity and transmittance were greater than neat 4320, and while haze was less. The coextruded materials also had lower shrinkage. The coextruded structure consistently had slightly less shrinkage than the 50/50% blend.

Adding 5% mRCP or HL-328 to a 50/50 3365/4320 blend also yielded materials where yield stresses were reduced, matching or nearly matching neat 4320. The ternary blend had low gloss (matte finish) where the gloss was reduced to ˜50, matching neat 4320 and the A/B/A coextruded structure. This same material had a transmittance that nearly matched neat 3365, with clarity greater than the 50/50 blend and a haze value that was much lower than the blend. The ternary blend also had a lower modulus. The modulus values were synergistically lowered to 225 to 230 kpsi, matching what would be achieved in a 20/80 3365/4320 blend.

TABLE 2-1
Materials Used

Sheet Structures
Neat 3365
Neat 4320
3365/4320
(50:50 wt % blend)
4320/3365/4320
(25/50/25 wt % coextruded)
3365/4320/mRCP
(47.5/47.5/5 wt % blend)
3365/4320/HL-328
(47.5/47.5/5 wt % blend)

TABLE 2-2
Film Optical Property Data

| | Temp | Time | | Trans | | Haze | | Clarity | Gloss | Gloss |
|---|---|---|---|---|---|---|---|---|---|---|
| Material | ° C. | (sec) | Transmittance | Std Dev | Haze % | Std Dev. | Clarity | Std. Dev. | (45°) | Std. Dev. |
| 3365 | 135 | 20 | 93.9 | 0.05 | 0.6 | 0.06 | 97.1 | 0.38 | 93.3 | 0.34 |
| | | 30 | 93.9 | 0.04 | 0.5 | 0.05 | 97.2 | 0.38 | 93.1 | .045 |
| | | 60 | 93.8 | 0.09 | 0.5 | 0.06 | 97.2 | 0.35 | 92.8 | 0.33 |
| | | 90 | 93.8 | 0.11 | 0.7 | 0.14 | 96.9 | 0.42 | 92.5 | 0.64 |
| 4320 | 135 | 20 | 84.4 | 1.54 | 51.8 | 2.18 | 26.8 | 1.42 | 49.6 | 3.97 |
| | | 30 | 79.6 | 1.01 | 63.2 | 2.17 | 19.0 | 1.35 | 53.8 | 4.19 |
| | | 60 | 78.3 | 1.28 | 68.2 | 3.61 | 16.3 | 1.67 | 55.2 | 4.61 |
| 4320/3365/4320 | 135 | 20 | 88.9 | 0.23 | 38.3 | 2.38 | 41.9 | 2.71 | 45.9 | 2.64 |
| 25/50/25 wt % | | 30 | 85.9 | 0.62 | 45.5 | 2.59 | 36.1 | 3.45 | 51.1 | 5.36 |
| | | 60 | 85.0 | 0.72 | 51.4 | 3.46 | 32.5 | 2.77 | 54.1 | 3.07 |
| 3365/4320/HL-328 | 135 | 20 | 92.8 | 0.28 | 15.4 | 0.66 | 57.6 | 1.15 | 48.9 | 2.52 |
| 47.5/47.5/5 wt % | | 30 | 92.3 | 0.33 | 17.4 | 0.77 | 55.2 | 1.09 | 51.9 | 4.18 |
| | | 60 | 91.1 | 0.37 | 21.0 | 2.02 | 52.2 | 1.99 | 51.4 | 3.44 |
| | | 90 | 89.4 | 1.32 | 26.1 | 1.84 | 48.2 | 1.08 | 58.1 | 6.31 |
| 3365/4320/mRCP | 135 | 20 | 93.6 | 0.12 | 9.6 | 0.62 | 69.0 | 0.95 | 56.9 | 2.58 |
| 47.5/47.5/5 wt % | | 30 | 93.1 | 0.31 | 10.8 | 0.44 | 67.6 | 0.92 | 57.2 | 2.46 |
| | | 60 | 92.7 | 0.24 | 12.9 | 0.63 | 64.8 | 1.09 | 58.0 | 1.79 |
| | | 90 | 91.3 | 0.64 | 16.1 | 0.73 | 61.5 | 0.96 | 60.1 | 4.41 |
| 3365/4320 | 135 | 20 | 88.1 | 0.31 | 23.3 | 1.69 | 54.2 | 2.10 | 68.0 | 3.32 |
| 50:50 wt % | | 30 | 87.6 | 0.50 | 25.7 | 1.61 | 51.6 | 1.76 | 71.7 | 2.32 |
| | | 60 | 83 | 0.54 | 37.5 | 1.91 | 40.0 | 1.84 | 77.8 | 3.88 |
| | | 90 | 80.7 | 0.96 | 43.4 | 3.04 | 35.0 | 2.52 | 82.7 | 4.28 |

TABLE 2-3
Film Water Vapor Transmission Rate Data

| | | | | | | Average |
|---|---|---|---|---|---|---|
| | | | WVTR#1 | WVTR#2 | Film | WVTR |
| | | | (g/100 in²/ | (g/100 in²/ | Thickness | g · mil/100 in²/ |
| Material | Temp (° C.) | Time (sec) | day) | day) | (mils) | day) |
| 3365 | 135 | 20 | 0.656 | 0.638 | 0.55 | 0.356 |
| 50/50% | 135 | 20 | 0.872 | 0.871 | 0.52 | 0.453 |
| Blend of | | | | | | |
| 3365 & | | | | | | |
| 4320 | | | | | | |
| 25/50/25 | 135 | 20 | 0.821 | 0.847 | 056 | 0.467 |
| Coextruded | | | | | | |
| Blend + 5% | 135 | 20 | 0.890 | 0.916 | 0.54 | 0.487 |
| mRCP | | | | | | |
| Blend + 5% | 135 | 20 | 0.974 | 0.975 | 0.55 | 0.536 |
| HL-328 | | | | | | |
| 4320 | 135 | 20 | 1.207 | 1.138 | 0.57 | 0.668 |
| 3365 | 135 | 60 | 0.664 | 0.690 | 0.56 | 0.379 |
| 50/50% | 135 | 60 | 0.874 | 0.893 | 0.58 | 0.512 |
| Blend of | | | | | | |
| 3365 & | | | | | | |
| 4320 | | | | | | |
| 25/50/25 | 135 | 60 | 0.935 | 0.874 | 0.56 | 0.506 |
| Coextruded | | | | | | |
| Blend + 5% | 135 | 60 | 0.920 | 0.879 | 0.56 | 0.503 |
| mRCP | | | | | | |
| Blend + 5% | 135 | 60 | 0.892 | 0.903 | 0.58 | 0.520 |
| HL-328 | | | | | | |
| 4320 | 135 | 60 | 1.144 | 1.182 | 0.58 | 0.675 |

TABLE 2-4
Machine Direction Tensile Property Data

| | | | | MD | | | | MD | | |
|---|---|---|---|---|---|---|---|---|---|---|
| | | | MD | Tensile | | | | 1% | | |
| | | | Tensile | Str. | | MD | MD 1% | Sec. | MD2% | |
| | Stretch | Stretch | Str. | @Break | MD | Elongation | Sec. | Mod. | Sec. | MD2% |
| | Temp. | Time | @Break | (Std | Elongation | @Break | Mod. | (Std | Mod. | Sec. |
| Material | ° C. | (Sec) | (kpsi) | Dev.) | @Break % | (Std Dev.) | (kpsi) | Dev.) | (kpsi) | Mod |
| 3365 | 135 | 20 | 29.74 | 2.34 | 70.7 | 15.5 | 327.53 | 8.37 | 216.92 | 7.72 |
| 3365/4320 | 135 | 20 | 27.73 | 1.62 | 62.5 | 5.1 | 260.96 | 19.26 | 176.89 | 12.28 |
| 50/50 Wt % | | | | | | | | | | |
| 4320/3365/4320 | 135 | 20 | 26.08 | 1.60 | 56.4 | 4.7 | 252.77 | 17.87 | 170.75 | 12.18 |
| 25/50/25 Wt % | | | | | | | | | | |
| 3365/4320/mRCP | 135 | 20 | 29.61 | 2.1 | 74.4 | 9.8 | 230.20 | 23.00 | 155.38 | 16.55 |
| 47.5/47.5/5 Wt % | | | | | | | | | | |
| 3365/4320/HL-328 | 135 | 20 | 28.97 | 2.21 | 80.4 | 9.3 | 224.50 | 23.88 | 153.40 | 17.81 |
| 47.5/47.5/5 wt % | | | | | | | | | | |
| 4320 | 135 | 20 | 22.70 | 2.09 | 52.7 | 9.2 | 199.94 | 12.56 | 139.86 | 8.21 |

TABLE 2-5
Machine Direction Yield Stress Properties
(FIG. 3)

| | Preheating | MD Yield |
|---|---|---|
| Material | Time (sec) | Stress (MPa) |
| Total Petrochemicals 3365 | 20 | 7.84E+00 |
| Total Petrochemicals 3365 | 30 | 7.93E+00 |
| Total Petrochemicals 3365 | 60 | 8.26E+00 |
| Total Petrochemicals 3365 | 90 | 8.68E+00 |
| Total Petrochemicals 4320 | 20 | 6.27E+00 |
| Total Petrochemicals 4320 | 30 | 6.73E+00 |
| Total Petrochemicals 4320 | 60 | 6.65E+00 |
| Coex. 4320/3365/4320 (25/50/25 wt %) | 20 | 7.43E+00 |
| Coex. 4320/3365/4320 (25/50/25 wt %) | 30 | 7.39E+00 |
| Coex. 4320/3365/4320 (25/50/25 wt %) | 60 | 7.48E+00 |
| 3365/4320 Blend (50/50 wt %) | 20 | 7.19E+00 |
| 3365/4320 Blend (50/50 wt %) | 30 | 7.32E+00 |
| 3365/4320 Blend (50/50 wt %) | 60 | 7.75E+00 |
| 3365/4320 Blend (50/50 wt %) | 90 | 7.79E+00 |

TABLE 2-6
Machine Direction Max Draw Properties

| | Preheating | MD Max Draw |
|---|---|---|
| Material | Time (sec) | Stress (MPa) |
| Total Petrochemicals 3365 | 20 | 7.66 |
| Total Petrochemicals 3365 | 30 | 7.44 |
| Total Petrochemicals 3365 | 60 | 6.97 |
| Total Petrochemicals 3365 | 90 | 6.67 |
| Total Petrochemicals 4320 | 20 | 6.08 |
| Total Petrochemicals 4320 | 30 | 6.01 |
| Total Petrochemicals 4320 | 60 | 5.54 |
| Coex. 4320/3365/4320 (25/50/25 wt %) | 20 | 6.92 |
| Coex. 4320/3365/4320 (25/50/25 wt %) | 30 | 6.78 |
| Coex. 4320/3365/4320 (25/50/25 wt %) | 60 | 6.12 |
| 3365/4320 Blend (50/50 wt %) | 20 | 6.65 |
| 3365/4320 Blend (50/50 wt %) | 30 | 6.41 |
| 3365/4320 Blend (50/50 wt %) | 60 | 6.18 |
| 3365/4320 Blend (50/50 wt %) | 90 | 5.84 |

TABLE 2-7
Machine Direction Yield Stress Properties
(FIG. 4)

| | Preheating | MD Yield |
|---|---|---|
| Material | Time (sec) | Stress (MPa) |
| Total Petrochemicals 4320 | 20 | 6.27 |
| Total Petrochemicals 4320 | 30 | 6.73 |
| Total Petrochemicals 4320 | 60 | 6.65 |
| 3365/4320 Blend (50/50 wt %) | 20 | 7.19 |
| 3365/4320 Blend (50/50 wt %) | 30 | 7.32 |
| 3365/4320 Blend (50/50 wt %) | 60 | 7.75 |
| 3365/4320 Blend (50/50 wt %) | 90 | 7.79 |
| 3365/4320/HL328 (47.5/47.5/5.0 wt %) | 20 | 6.29 |
| 3365/4320/HL328 (47.5/47.5/5.0 wt %) | 30 | 6.42 |
| 3365/4320/HL328 (47.5/47.5/5.0 wt %) | 60 | 6.62 |
| 3365/4320/HL328 (47.5/47.5/5.0 wt %) | 90 | 6.76 |
| 3365/4320/mRCP (47.5/47.5/5.0 wt %) | 20 | 6.61 |
| 3365/4320/mRCP (47.5/47.5/5.0 wt %) | 30 | 6.46 |
| 3365/4320/mRCP (47.5/47.5/5.0 wt %) | 60 | 6.65 |
| 3365/4320/mRCP (47.5/47.5/5.0 wt %) | 90 | 6.77 |

TABLE 2-8
Machine Direction Max Draw Properties

| | Preheating | MD Max Draw |
|---|---|---|
| Material | Time (sec) | Stress (MPa) |
| Total Petrochemicals 4320 | 20 | 6.08 |
| Total Petrochemicals 4320 | 30 | 6.01 |
| Total Petrochemicals 4320 | 60 | 5.54 |
| 3365/4320 Blend (50/50 wt %) | 20 | 6.65 |
| 3365/4320 Blend (50/50 wt %) | 30 | 6.41 |
| 3365/4320 Blend (50/50 wt %) | 60 | 6.18 |
| 3365/4320 Blend (50/50 wt %) | 90 | 5.84 |
| 3365/4320/HL328 (47.5/47.5/5.0 wt %) | 20 | 6.52 |
| 3365/4320/HL328 (47.5/47.5/5.0 wt %) | 30 | 6.27 |
| 3365/4320/HL328 (47.5/47.5/5.0 wt %) | 60 | 5.98 |
| 3365/4320/HL328 (47.5/47.5/5.0 wt %) | 90 | 5.85 |
| 3365/4320/mRCP (47.5/47.5/5.0 wt %) | 20 | 6.77 |
| 3365/4320/mRCP (47.5/47.5/5.0 wt %) | 30 | 6.28 |
| 3365/4320/mRCP (47.5/47.5/5.0 wt %) | 60 | 5.95 |
| 3365/4320/mRCP (47.5/47.5/5.0 wt %) | 90 | 5.92 |

TABLE 2-9
Optical Properties

| | Preheating | | | | |
|---|---|---|---|---|---|
| Material | Time (sec) | 45° Gloss | Transmittance | Haze (%) | Clarity |
| Total Petrochemicals 3365 | 20 | 93.3 | 93.9 | 0.6 | 97.1 |
| Total Petrochemicals 3365 | 30 | 93.1 | 93.9 | 0.5 | 97.2 |
| Total Petrochemicals 3365 | 60 | 92.8 | 93.8 | 0.5 | 97.2 |
| Total Petrochemicals 3365 | 90 | 92.5 | 93.8 | 0.7 | 96.9 |
| Total Petrochemicals 4320 | 20 | 49.6 | 84.4 | 51.8 | 26.8 |
| Total Petrochemicals 4320 | 30 | 53.8 | 79.6 | 63.2 | 19.0 |
| Total Petrochemicals 4320 | 60 | 55.2 | 78.3 | 68.2 | 16.3 |
| Coex. 4320/3365/4320 (25/50/25 wt %) | 20 | 45.9 | 88.9 | 38.3 | 41.9 |
| Coex. 4320/3365/4320 (25/50/25 wt %) | 30 | 51.1 | 85.9 | 45.5 | 36.1 |
| Coex. 4320/3365/4320 (25/50/25 wt %) | 60 | 54.1 | 85.0 | 51.4 | 32.5 |
| 3365/4320 Blend (50/50 wt %) | 20 | 68.0 | 88.1 | 23.3 | 54.2 |
| 3365/4320 Blend (50/50 wt %) | 30 | 71.7 | 87.6 | 25.7 | 51.6 |
| 3365/4320 Blend (50/50 wt %) | 60 | 77.8 | 83.0 | 37.5 | 40.0 |
| 3365/4320 Blend (50/50 wt %) | 90 | 82.7 | 80.7 | 43.4 | 35.0 |

TABLE 2-10
Optical Properties

| | Preheating | | | | |
|---|---|---|---|---|---|
| Material | Time (sec) | 45° Gloss | Transmittance | Haze (%) | Clarity |
| Total Petrochemicals 4320 | 20 | 49.6 | 84.4 | 51.8 | 26.8 |
| Total Petrochemicals 4320 | 30 | 53.8 | 79.6 | 63.2 | 19.0 |
| Total Petrochemicals 4320 | 60 | 55.2 | 78.3 | 68.2 | 16.3 |
| 3365/4320 Blend (50/50 wt %) | 20 | 68.0 | 88.1 | 23.3 | 54.2 |
| 3365/4320 Blend (50/50 wt %) | 30 | 71.7 | 87.6 | 25.7 | 51.6 |
| 3365/4320 Blend (50/50 wt %) | 60 | 77.8 | 83.0 | 37.5 | 40.0 |
| 3365/4320 Blend (50/50 wt %) | 90 | 82.7 | 80.7 | 43.4 | 35.0 |
| 3365/4320/HL328 (47.5/47.5/5.0 wt %) | 20 | 48.9 | 92.8 | 15.4 | 57.6 |
| 3365/4320/HL328 (47.5/47.5/5.0 wt %) | 30 | 51.9 | 92.3 | 17.4 | 55.2 |
| 3365/4320/HL328 (47.5/47.5/5.0 wt %) | 60 | 51.4 | 91.1 | 21.0 | 52.2 |
| 3365/4320/HL328 (47.5/47.5/5.0 wt %) | 90 | 58.1 | 89.4 | 26.1 | 48.2 |
| 3365/4320/mRCP (47.5/47.5/5.0 wt %) | 20 | 56.9 | 93.6 | 9.6 | 69.0 |
| 3365/4320/mRCP (47.5/47.5/5.0 wt %) | 30 | 57.2 | 93.1 | 10.8 | 67.6 |
| 3365/4320/mRCP (47.5/47.5/5.0 wt %) | 60 | 58.0 | 92.7 | 12.9 | 64.8 |
| 3365/4320/mRCP (47.5/47.5/5.0 wt %) | 90 | 60.1 | 91.3 | 16.1 | 61.5 |

TABLE 2-11
Water Vapor Transfer Rate Properties

| | | WVTR |
|---|---|---|
| | Preheating | (g · mil/100 in²/ |
| Material | Time (sec) | day) |
| Total Petrochemicals 3365 | 20 | 0.36 |
| 3365/4320 Blend (50/50 wt %) | 20 | 0.45 |
| 25/50/25% Coex | 20 | 0.47 |
| 3365/4320/mRCP (47.5/47.5/5.0 wt %) | 20 | 0.49 |
| 3365/4320/HL328 (47.5/47.5/5.0 wt %) | 20 | 0.54 |
| Total Petrochemicals 4320 | 20 | 0.67 |

TABLE 2-12
Machine Direction 1% Secant Modulus Properties

| | MD 1% Sec. | |
|---|---|---|
| Material | Mod. (kpsi) | % 3365 |
| Total Petrochemicals 3365 | 327.5 | 100.0 |
| 3365/4320 Blend (50/50 wt %) | 261.0 | 50.0 |
| 25/50/25% Coex | 252.8 | 50.0 |
| 3365/4320/mRCP | 230.2 | 47.5 |
| (47.5/47.5/5.0 wt %) | | |
| 3365/4320/HL328 | 224.5 | 47.5 |
| (47.5/47.5/5.0 wt %) | | |
| Total Petrochemicals 4320 | 199.9 | 0.0 |

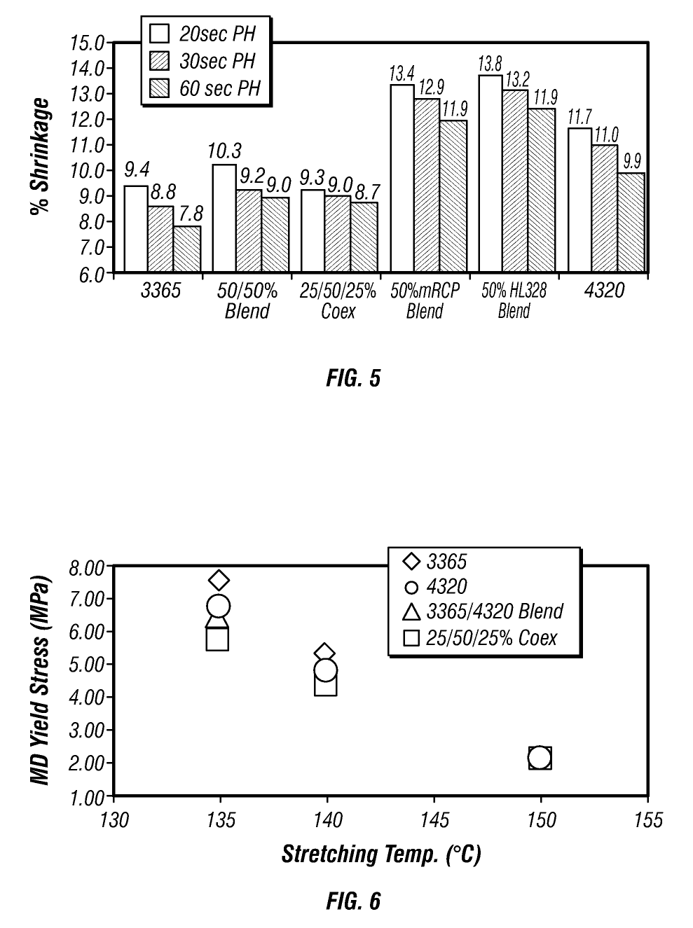

TABLE 2-13
Shrinkage Properties
(FIG. 5)

| | Preheating | |
|---|---|---|
| Material | Time (sec) | Shrinkage (%) |
| Total Petrochemicals 3365 | 20 | 9.4 |
| 3365/4320 Blend (50/50 wt %) | 20 | 10.3 |
| 25/50/25% Coex | 20 | 9.3 |
| 3365/4320/mRCP (47.5/47.5/5.0 wt %) | 20 | 13.4 |
| 3365/4320/HL328 (47.5/47.5/5.0 wt %) | 20 | 13.8 |
| Total Petrochemicals 4320 | 20 | 11.7 |
| Total Petrochemicals 3365 | 30 | 8.6 |
| 3365/4320 Blend (50/50 wt %) | 30 | 9.2 |
| 25/50/25% Coex | 30 | 9.0 |
| 3365/4320/mRCP (47.5/47.5/5.0 wt %) | 30 | 12.9 |
| 3365/4320/HL328 (47.5/47.5/5.0 wt %) | 30 | 13.2 |
| Total Petrochemicals 4320 | 30 | 11.0 |
| Total Petrochemicals 3365 | 60 | 7.8 |
| 3365/4320 Blend (50/50 wt %) | 60 | 9.0 |
| 25/50/25% Coex | 60 | 8.7 |
| 3365/4320/mRCP (47.5/47.5/5.0 wt %) | 60 | 11.9 |
| 3365/4320/HL328 (47.5/47.5/5.0 wt %) | 60 | 12.5 |
| Total Petrochemicals 4320 | 60 | 9.9 |

### Example 3

### Bruckner Orientation Evaluation

Six 16 mil sheets were prepared using the materials disclosed in Table 3-1 substantially similarly to Example 2. All six were stretched uniaxially to an 8:1 draw ratio. The resultant samples were tested using a Bruckner film stretcher. Stretching temperatures were varied during the evaluation and the results shown in FIGS. 6 & 7 and Tables 3-1 through 3-11.

### Discussion of Example 3 Results

The coextruded films displayed improvements which included easing stretching forces such that stretching forces were reduced relative to neat 3365. These materials also showed decreasing temperature effects so that stretching forces were less dependent on temperature. The coextruded materials also had a had a dull finish like neat 4320, but the core of isotactic propylene homopolymer resulting in desirable physical properties.

The ternary blends using a third component as a resin modifier also showed an easing of stretching forces. Stretching forces were reduced relative to both neat 3365 and the 3365/4320 (50/50 wt %) structures. The ternary blend also showed decreasing temperature effects where the stretching forces were less dependent on temperature, approaching or exceeding the behavior of neat 4320. The ternary blend also had a dull finish. Using polyethylene as the resin modifier produced films duller than the 3365/4320 (50/50 wt %) structures. Both ternary blends were duller than neat 3365.

TABLE 3-1
Materials Used

Sheet Structures
Neat 3365
Neat 4320
3365/4320
(50:50 wt % blend)
4320/3365/4320
(25/50/25 wt % coextruded)
3365/4320/mRCP
47.5/47.5/5 wt % blend)
3365/4320/HL-328
(47.5/47.5/5 wt % blend)

TABLE 3-2
Slopes of yield stress versus stretching temperature.

| Material | Slope |
|---|---|
| Neat 3365 | −0.315 |
| Neat 4320 | −0.259 |
| 3365/4320 | −0.266 |
| (50:50 wt % blend) | |
| 4320/3365/4320 | −0.231 |
| (25/50/25 wt % coextruded) | |
| 3365/4320/mRCP | −0.210 |
| (47.5/47.5/5 wt % blend) | |
| 3365/4320/HL-328 | −0.215 |
| (47.5/47.5/5 wt % blend) | |

TABLE 3-3
Machine Direction Yield Stress Properties
(FIG. 6)

| | Oven Temp. | MD Yield |
|---|---|---|
| Material | (° C.) | Stress (Mpa) |
| Total Petrochemicals 3365 | 135 | 7.58 |
| Total Petrochemicals 3365 | 140 | 5.30 |
| Total Petrochemicals 3365 | 150 | 2.17 |
| 3365/4320 Blend (50/50 wt %) | 135 | 6.42 |
| 3365/4320 Blend (50/50 wt %) | 140 | 4.89 |
| 3365/4320 Blend (50/50 wt %) | 150 | 2.04 |
| 25/50/25% Coex | 135 | 6.68 |
| 25/50/25% Coex | 140 | 4.80 |
| 25/50/25% Coex | 150 | 2.11 |
| Total Petrochemicals 4320 | 135 | 5.67 |
| Total Petrochemicals 4320 | 140 | 4.40 |
| Total Petrochemicals 4320 | 150 | 2.03 |

TABLE 3-4
Machine Direction Draw Stress Properties

| | | MD Final |
|---|---|---|
| | Oven Temp. | Draw Stress |
| Material | (° C.) | (MPa) |
| Total Petrochemicals 3365 | 135 | 8.71 |
| Total Petrochemicals 3365 | 140 | 7.60 |
| Total Petrochemicals 3365 | 150 | 4.87 |
| 3365/4320 Blend (50/50 wt %) | 135 | 7.68 |
| 3365/4320 Blend (50/50 wt %) | 140 | 7.19 |
| 3365/4320 Blend (50/50 wt %) | 150 | 4.46 |
| 25/50/25% Coex | 135 | 8.05 |
| 25/50/25% Coex | 140 | 7.04 |
| 25/50/25% Coex | 150 | 4.41 |
| Total Petrochemicals 4320 | 135 | 7.11 |
| Total Petrochemicals 4320 | 140 | 6.56 |
| Total Petrochemicals 4320 | 150 | 3.95 |

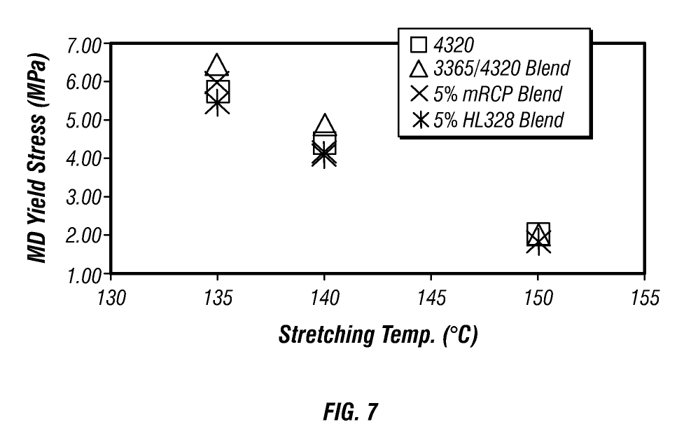

TABLE 3-5
Machine Direction Yield Stress Properties
(FIG. 7)

| | Oven Temp. | MD Yield |
|---|---|---|
| Material | (° C.) | Stress (MPa) |
| Total Petrochemicals 4320 | 135 | 5.67 |
| Total Petrochemicals 4320 | 140 | 4.40 |
| Total Petrochemicals 4320 | 150 | 2.03 |
| 3365/4320 Blend (50/50 wt %) | 135 | 6.42 |
| 3365/4320 Blend (50/50 wt %) | 140 | 4.89 |
| 3365/4320 Blend (50/50 wt %) | 150 | 2.04 |
| 3365/4320/HL328 (47.5/47.5/5.0 wt %) | 135 | 5.44 |
| 3365/4320/HL328 (47.5/47.5/5.0 wt %) | 140 | 4.04 |
| 3365/4320/HL328 (47.5/47.5/5.0 wt %) | 150 | 1.85 |
| 3365/4320/mRCP (47.5/47.5/5.0 wt %) | 135 | 5.90 |
| 3365/4320/mRCP (47.5/47.5/5.0 wt %) | 140 | 4.17 |
| 3365/4320/mRCP (47.5/47.5/5.0 wt %) | 150 | 1.90 |

TABLE 3-6
Machine Direction Draw Stress Properties

| | | MD Final |
|---|---|---|
| | Oven Temp. | Draw Stress |
| Material | (° C.) | (MPa) |
| Total Petrochemicals 4320 | 135 | 7.11 |
| Total Petrochemicals 4320 | 140 | 6.56 |
| Total Petrochemicals 4320 | 150 | 3.95 |
| 3365/4320 Blend (50/50 wt %) | 135 | 7.68 |
| 3365/4320 Blend (50/50 wt %) | 140 | 7.19 |
| 3365/4320 Blend (50/50 wt %) | 150 | 4.46 |
| 3365/4320/HL328 (47.5/47.5/5.0 wt %) | 135 | 7.11 |
| 3365/4320/HL328 (47.5/47.5/5.0 wt %) | 140 | 6.72 |
| 3365/4320/HL328 (47.5/47.5/5.0 wt %) | 150 | 4.15 |
| 3365/4320/mRCP (47.5/47.5/5.0 wt %) | 135 | 7.48 |
| 3365/4320/mRCP (47.5/47.5/5.0 wt %) | 140 | 6.72 |
| 3365/4320/mRCP (47.5/47.5/5.0 wt %) | 150 | 4.22 |

TABLE 3-7
Optical Properties

| | Oven Temp. | |
|---|---|---|
| Material | (° C.) | 45° Gloss |
| Total Petrochemicals 3365 | 135 | 53.8 |
| Total Petrochemicals 3365 | 140 | 56.9 |
| Total Petrochemicals 3365 | 150 | 26.1 |
| 3365/4320 Blend (50/50 wt %) | 135 | 23.1 |
| 3365/4320 Blend (50/50 wt %) | 140 | 22.1 |
| 3365/4320 Blend (50/50 wt %) | 150 | 19.6 |
| 25/50/25% Coex | 135 | 15.5 |
| 25/50/25% Coex | 140 | 14.6 |
| 25/50/25% Coex | 150 | 19.7 |
| Total Petrochemicals 4320 | 135 | 14.6 |
| Total Petrochemicals 4320 | 140 | 13.6 |
| Total Petrochemicals 4320 | 150 | 16.3 |

TABLE 3-8
Optical Properties

| | Oven Temp. | |
|---|---|---|
| Material | (° C.) | 45° Gloss |
| Total Petrochemicals 4320 | 135 | 14.6 |
| Total Petrochemicals 4320 | 140 | 13.6 |
| Total Petrochemicals 4320 | 150 | 16.3 |
| 3365/4320 Blend (50/50 wt %) | 135 | 23.1 |
| 3365/4320 Blend (50/50 wt %) | 140 | 22.1 |
| 3365/4320 Blend (50/50 wt %) | 150 | 19.6 |
| 3365/4320/HL328 (47.5/47.5/5.0 wt %) | 135 | 17.5 |
| 3365/4320/HL328 (47.5/47.5/5.0 wt %) | 140 | 18.7 |
| 3365/4320/HL328 (47.5/47.5/5.0 wt %) | 150 | 26.1 |
| 3365/4320/mRCP (47.5/47.5/5.0 wt %) | 135 | 25.4 |
| 3365/4320/mRCP (47.5/47.5/5.0 wt %) | 140 | 25.9 |
| 3365/4320/mRCP (47.5/47.5/5.0 wt %) | 150 | 31.7 |

TABLE 3-9
Machine Direction Shrinkage Properties

| | MD |
|---|---|
| | Shrinkage |
| Material | (%) |
| Total Petrochemicals 3365 | 2.35 |
| 3365/4320 Blend (50/50 wt %) | 2.35 |
| 25/50/25% Coex | 2.35 |
| 3365/4320/mRCP (47.5/47.5/5.0 wt %) | 2.94 |
| 3365/4320/HL328 (47.5/47.5/5.0 wt %) | 3.53 |
| Total Petrochemicals 4320 | 2.35 |

TABLE 3-10
1% Secant Modulus Properties

| | Oven Temp. | 1% Secant |
|---|---|---|
| Material | (° C.) | Mod. (kpsi) |
| Total Petrochemicals 3365 | 135 | 656.6 |
| Total Petrochemicals 3365 | 150 | 470.3 |
| 3365/4320 Blend (50/50 wt %) | 135 | 551.9 |
| 3365/4320 Blend (50/50 wt %) | 150 | 390.5 |
| 25/50/25% Coex | 135 | 575.0 |
| 25/50/25% Coex | 150 | 430.6 |
| Total Petrochemicals 4320 | 135 | 480.9 |
| Total Petrochemicals 4320 | 150 | 348.0 |

TABLE 3-11
1% Secant Modulus Properties

| | Oven Temp. | 1% Secant |
|---|---|---|
| Material | (° C.) | Mod. (kpsi) |
| Total Petrochemicals 4320 | 135 | 480.9 |
| Total Petrochemicals 4320 | 150 | 348.0 |
| 3365/4320 Blend (50/50 wt %) | 135 | 551.9 |
| 3365/4320 Blend (50/50 wt %) | 150 | 390.5 |
| 3365/4320/HL328 (47.5/47.5/5.0 wt %) | 135 | 508.2 |
| 3365/4320/HL328 (47.5/47.5/5.0 wt %) | 150 | 375.2 |
| 3365/4320/mRCP (47.5/47.5/5.0 wt %) | 135 | 505.3 |
| 3365/4320/mRCP (47.5/47.5/5.0 wt %) | 150 | 363.0 |

What is claimed is:

1. A polypropylene fiber, film, or sheet comprising a melt blended admixture of a heterophasic propylene copolymer and an isotactic propylene homopolymer
wherein the heterophasic propylene copolymer
has an ethylene content of from about 5% to about 25% by weight of copolymer and
is present in an amount of greater than 40% to about 75% by weight of polymer blend and
has a MFR of from about 4 to about 25 g/10 minutes.

2. The polypropylene fiber, film, or sheet of claim 1 wherein heterophasic propylene copolymer has a MFR of from about 10 to 20 g/10 minutes.

3. The polypropylene fiber, film, or sheet of claim 1 wherein the isotactic homopolymer has a MFR of from about 2 to about 8 g/10 minutes.

4. A polypropylene fiber, film, or sheet comprising a melt blended admixture of a heterophasic propylene copolymer; an isotactic propylene homopolymer; and a polymer selected from the group consisting of polyethylene and single phase random propylene copolymers;
wherein the heterophasic propylene copolymer
has an ethylene content of from about 5% to about 25% by weight of copolymer and
is present in an amount of from about 5% to about 90% by weight of polymer blend.

5. The polypropylene fiber, film, or sheet of claim 4 wherein heterophasic propylene copolymer has a MFR of from about 2 to 8 g/10 minutes.

6. The polypropylene fiber, film, or sheet of claim 4 wherein heterophasic propylene copolymer has a MFR of from about 10 to 20 g/10 minutes.

7. The polypropylene fiber, film, or sheet of claim 4 wherein the isotactic homopolymer has a MFR of from about 2 to about 8 g/10 minutes.

8. The polypropylene fiber, film, or sheet of claim 4 wherein the polyethylene has a density of from about 0.85 to about 0.97.

9. The polypropylene fiber, film, or sheet of claim 8 wherein the admixture includes polyethylene and the polyethylene has a density of 0.937.

10. The polypropylene fiber, film, or sheet of claim 4 wherein the admixture includes the single phase random propylene copolymer.

11. The polypropylene fiber, film, or sheet of claim 10 wherein the single phase random propylene copolymer has a melting point of from about 110 to about 155° C.

12. The polypropylene fiber, film, or sheet of claim 10 wherein the single phase random propylene copolymer has a MFR of from about 0.5 to about 50 g/10 minutes.

13. The polypropylene fiber, film, or sheet of claim 10 wherein the single phase random propylene copolymer has a MFR of about 12 g/10 minutes and a melting point of about 120° C.

14. The polypropylene fiber, film, or sheet of claim 13 wherein the single phase random propylene copolymer is prepared using a metallocene catalyst.

15. A composition comprising a melt blended admixture of a heterophasic propylene copolymer; an isotactic propylene homopolymer; and a polymer selected from the group consisting of polyethylene and single phase random propylene copolymers;
wherein the heterophasic propylene copolymer
has an ethylene content of from about 5% to about 25% by weight of copolymer and
is present in an amount of from about 5% to about 90% by weight of polymer blend.

16 A polypropylene material compromising a three layer coextruded film or sheet prepared by the coextrusion of a first layer, a second or middle layer, and a third layer, wherein each layer is prepared using a material selected from the group consisting of a heterophasic propylene copolymer;
an isotactic propylene homopolymer;
a melt blended admixture of a heterophasic propylene copolymer and an isotactic propylene homopolymer
wherein the heterophasic propylene copolymer
has an ethylene content of from about 5% to about 25% by weight of copolymer and
is present in an amount of greater than 40% to about 75% by weight of polymer blend; and
a melt blended admixture of a heterophasic propylene copolymer; an isotactic propylene homopolymer; and a polymer selected from the group consisting of polyethylene and single phase random propylene copolymers;
wherein the heterophasic propylene copolymer
has an ethylene content of from about 5% to about 25% by weight of copolymer and
is present in an amount of from about 5% to about 90% by weight of polymer blend.

17. The three layer coextruded film or sheet of claim 16 wherein the second or middle layer is prepared using an isotactic propylene homopolymer and the first layer and third layer are prepared using a heterophasic propylene copolymer.

18. The three layer coextruded film or sheet of claim 16 wherein the second or middle layer is prepared using a melt blended admixture of a heterophasic propylene copolymer and an isotactic propylene homopolymer
wherein the heterophasic propylene copolymer
has an ethylene content of from about 5% to about 25% by weight of copolymer and
is present in an amount of greater than 40% to about 75% by weight of polymer blend; and
the first layer and third layer are prepared using a heterophasic propylene copolymer.

19. The three layer coextruded film or sheet of claim 16 wherein the second or middle layer is prepared using a melt blended admixture of a heterophasic propylene copolymer; an isotactic propylene homopolymer; and a polymer selected from the group consisting of polyethylene and single phase random propylene copolymers;
wherein the heterophasic propylene copolymer
has an ethylene content of from about 5% to about 25% by weight of copolymer and
is present in an amount of from about 5% to about 90% by weight of polymer blend; and
the first layer and third layer are prepared using a heterophasic propylene copolymer.

20. The three layer coextruded film or sheet of claim 16 wherein the first layer is a heterophasic propylene copolymer; the second or middle layer is prepared using an isotactic propylene homopolymer; and the third layer is prepared using a melt blended admixture of a heterophasic propylene copolymer; an isotactic propylene homopolymer; and a polymer selected from the group consisting of polyethylene and single phase random propylene copolymers;
wherein the heterophasic propylene copolymer
has an ethylene content of from about 5% to about 25% by weight of copolymer and
is present in an amount of from about 5% to about 90% by weight of polymer blend.
